(19) United States
(12) Patent Application Publication
(10) Pub. No.: US 2013/0240445 A1
(43) Pub. Date: Sep. 19, 2013

(54) POLYPHENOL-TYPE POLYMER COATING OF FILTRATION MEMBRANES

(71) Applicants: Kristof VIZVARDI, Budapest (HU); Zoltan A. FEKETE, Szarliget (HU)

(72) Inventors: Kristof VIZVARDI, Budapest (HU); Zoltan A. FEKETE, Szarliget (HU)

(73) Assignee: GENERAL ELECTRIC COMPANY, Schenectady, NY (US)

(21) Appl. No.: 13/422,255

(22) Filed: Mar. 16, 2012

(51) Int. Cl. B01D 71/28; B29C 65/48; C02F 1/44

(52) U.S. Cl. 210/650; 210/500.33; 156/296

(57) ABSTRACT

A filtration membrane is coated with a polymer made from a compound comprising a benzenediol or a substituted phenol, such as catechol. The polymer deposition process comprises exposing the membrane to the compound in an aqueous alkaline solution. A membrane module may be immersed in the solution. Optionally, the solution is aerated. The polymer coating is reasonably durable in aqueous environments but may be removable. In an example, a module of PVDF based outside-in hollow fiber membranes was coated with poly(catechol). The membranes had a reduced fouling rate and could be maintenance cleaned with water or a dilute oxidant solution. The polycatechol coating could be oxidized by cleaning the membrane with a hypochlorite solution and re-coated. The modified membranes may be used, for example, in water or wastewater treatment. A filtration process includes steps of oxidizing and re-applying the coating after the membrane has been in use.

### FIELD

This specification relates to coatings or surface modifications for filtration or other selective barrier membranes.

### BACKGROUND

The following discussion is not an admission that anything discussed below is common general knowledge or background knowledge of a person of ordinary skill in the art.

Filtration membranes are prone to fouling when they are in operation. In general, reducing the rate of fouling allows membranes to operate at a higher average or constant flux. With a higher operational flux, more filtered product can be produced from a given membrane module. Some attempts at developing low fouling membranes have focused on surface coatings. While the coating layer might increase the resistance of the membrane, the reduction in fouling rate may be sufficient to provide an advantage even it there is a small reduction in initial permeability.

U.S. Pat. Nos. 4,496,397 and 4,585,585, issued to J. Herbert Waite on Jan. 29, 1985 and Apr. 29, 1986 respectively, describe some of his work in purifying and stabilizing polyphenolic substances that are used as one of three parts of an adhesive system employed by marine mussels. The polyphenolic substance is a protein containing about 11% of 3,4-dihydroxyphenylalanine (DOPA) and about 13 percent of hydroxyproline.

In US Patent Publication Number 2010/0330025 A1, published on Dec. 30, 2010 to Messersmith et al., a surface such as the hull of a ship that is to be subjected to a marine environment is treated with an mPEG-DOPA. Somewhat ironically, the treated surface is rendered less susceptible to biofouling by marine organisms. In a more generic description of a method for modifying the surface of a substrate, the surface is contacted with an alkaline solution of a surface modifying agent under oxidative conditions. The surface modifying agent may be DOPA, dopamine, or other molecules made according to a formula given in the publication. The surface modifying agent forms a polymeric coating on the substrate. The surface-modified substrate may then be contacted with a reactive moiety. The reactive moiety may provide marine biofouling resistance to ships, as mentioned above.

Dopamine, or 3,4-dihydroxyphenylamine, is a derivative of DOPA having an amine group. In U.S. Pat. No. 8,017,050, issued on Sep. 13, 2011 to Freeman et al., a purification membrane is treated with dopamine to form a polydopamine coated membrane. The membranes are polymeric, for example of polsulfone (PS) or polyamide (PA). The polydopamine coating increased the surface hydrophilicity and reduced membrane fouling while not dramatically reducing the pure water flux of the membrane. The authors reported that the dopamine also adhered non-specifically to virtually any surface with which it came into contact.

The application of DOPA or dopamine to membranes has also been discussed in journal literature. In one article, Ultrathin and Stable Active Layer of Dense Composite Membrane Enabled by Poly(dopamine) (Li et al., Langmuir 2009, 25(13), 7368-7374), a composite membrane is made by dipping a microporous polysulfone (PS) support in an aqueous dopamine solution. The dopamine coating provides the active layer for a membrane used for pervaporative desulfurization. In another article, A facile method of surface modification for hydrophobic polymer membranes based on the adhesive behavior of poly(DOPA) and poly(dopamine) (Xi et al., Journal of Membrane Science 327 (2009) 244-253), DOPA and dopamine solutes self-polymerized and adhered to hydrophobic membrane surfaces in mild aqueous environments. Membranes of polyethylene (PE), polyvinylidene difluoride (PVDF) and polytetrafluoroethylene (PTFE) were coated by immersing them into a solution at 30 degrees C., and vibrating the solution, for a period of time. The surface-modified membranes became more hydrophilic and had elevated water fluxes. The durability of the coating was confirmed after washing the dopamine coated membrane in a shaken water bath at 60 degrees C. for 36 days.

### INTRODUCTION TO THE INVENTION

The following introduction is intended to introduce the reader to the detailed description to follow and not to limit or define any claimed invention.

A selective barrier membrane is modified with a coating of a polymer made from a compound, used for example as a monomer or co-monomer, comprising a benzenediol or a substituted phenol. The polymer attaches to the feed side surface of the membrane, and possibly the opening and the surfaces of the pores. The modified membranes may be used, for example, in a membrane bioreactor. The compound may be catechol, or a compound according to a structure that will be described in the detailed description.

The polymer deposition process comprises exposing the membrane to the compound in an aqueous alkaline solution. The membrane, or a membrane module, are immersed in the solution. Optionally, the solution is aerated. A polymer forms and adheres to the membrane surface.

The polymer coating is reasonably durable in neutral, aqueous solutions that are substantially free of oxidative agents. However, with at least some polymers, the coating may be oxidized, for example by cleaning the membranes with an oxidant. After one or more cycles of maintenance cleaning with an oxidant, the coating may still reduce fouling of the membrane. The coating may be re-applied if it is substantially removed over repeated mild cleanings or by more intense cleaning.

In an experimental example, a module of PVDF based ultrafiltration or microfiltration hollow fiber membranes, with the feed side on the outside of the membranes and intended for immersed suction driven filtration, was modified by immersing the module in a solution comprising catechol. The membranes emerged coated with a polymerized form of catechol. After the modification, the membranes had a brownish color and slightly higher clean water permeability. The membranes had a reduced fouling rate relative to uncoated membranes. The membrane could be cleaned by washing them with water alone. The polycatechol coating was partially oxidized after cleaning the membrane with a hypochlorite solution but the membranes still had a reduced fouling rate.

In a filtration process, maintenance cleaning can be provided with water or with mild chemical cleaning, for example with a hypochlorite solution. After recovery cleaning with a more concentrated oxidant solution, the membranes may be re-coated. At least some irreversible foulants attached to the coating may be released from the membrane during recovery cleaning.

The compositions, methods and products described in this specification are useful in providing one or more alternatives to the membrane coating technology described in the background section. In various applications, these alternatives might be beneficial because they provide one or more of, a membrane with increased hydrophilicity or reduced hydrophobicity relative to an uncoated membrane; a membrane with a reduced fouling rate in the application; a membrane with a removable coating; or, an alternative chemical system that is acceptable in production or in the application. The use of the compositions, methods and products described in this specification in large scale drinking water and wastewater treatment systems in particular will be discussed in the detailed description as a preferred, but not essential, application.

### BRIEF DESCRIPTION OF THE FIGURES

FIG. 1 is a photograph of two PVDF hollow fiber membranes in which the left membrane is uncoated and the right membrane has a grey-brown coating of polycatechol.

FIGS. 2, 3 and 4 are graphs showing the transmembrane pressure (TMP) of coated and uncoated immersed membrane modules operating in parallel at a constant flux in a membrane bioreactor.

### DETAILED DESCRIPTION

Selective barrier membranes, and filtering membranes in particular, include for example reverse osmosis (RO), nanofiltration (NF), ultrafiltration (UF) and microfiltration (MF) membranes. The membranes may be provided in various configurations such as flat sheet membranes, tubular membranes, hollow fiber membranes and other extruded forms. Flat sheet membranes may be packaged in modules in parallel or in a spiral wound configuration. The membrane material may be, for example, ceramic or polymeric.

Without intending to limit the compositions, methods and products described in this specification to any particular application, the inventors are particularly interested in using membranes for large municipal or commercial drinking water or waste water treatment applications, for example immersed membrane bioreactors. Many other membrane applications involve a few membrane modules that are exposed to a constant feed stream with only a few foulants, and the membranes may be discarded after months of use. In contrast, municipal water and wastewater treatment systems can require tens or hundreds of membrane modules with a total of thousands of square meters of surface area. These membranes filter feed waters containing, in a single feedwater stream, many different types of contaminants that vary in concentration over time. Accordingly, water and wastewater filtration membranes are prone to fouling by multiple fouling mechanisms. Despite this, membranes used in large water or wastewater treatment plants are expected to have a service life measured in years, for example 5 years or more.

To address the multiple fouling mechanisms, water and wastewater filtration membranes are subjected to multiple cleaning or flux maintenance regimens. Typically, the membranes have a filtration cycle that involves short periods, typically less than 60 minutes or less than 20 minutes, of permeation separated by a physical cleaning procedure such as backwashing or relaxation with aeration. Aeration may also be provided during some or all of the permeation time. In addition, maintenance cleaning procedures are used at a frequency ranging from roughly daily to monthly, and involve the application of cleaning chemicals for periods generally less than two hours long. But despite these procedures, less frequent recovery cleaning procedures involving more intensive chemical cleaning regimens are still necessary to partially reverse longer term fouling problems. Long term fouling phenomena are different from short term fouling effects, and the ability to partially recover permeability after, for example, every 3 months to a year in service, is important. However, some long term fouling effects are not reversible by ordinary recovery cleaning techniques and eventually contribute to the membranes being removed from service.

In accordance with the multiple time scales and procedures described above, several different fouling responses can be considered. Short term fouling rates can be measured in a permeation period between physical cleaning events, or across multiple permeation periods between successive maintenance cleaning events. A low fouling membrane is typically evaluated in this time scale. However, the ability of a membrane to recover at least a portion of its permeability after a maintenance cleaning event, the maintenance cleaning regime, and long term fouling are also important.

As described in more detail below, a low-fouling filtration membrane surface may be obtained by adhering a hydrophilic polyphenol-type polymer (POP) coating to a membrane. With at least some polymers, the coating may be strongly adhered to the membrane in a filtration environment and yet the polymer may be oxidized and the membranes may be re-coated, if necessary, preferably in the field. Maintenance cleaning may be with water or with a mild chemical solution. Cleaning with a mild oxidant, for example a hypochlorite solution of 200 ppm or less or 100 ppm or less, may cause the colour of the membrane to whiten but the reduced fouling qualities of the membrane remain after cleaning. Cleaning with a more concentrated oxidant, for example a hypochlorite solution of 500 ppm or more, may remove a substantial portion of the coating, but the coating may be re-applied. In this way, some foulants that might otherwise be irreversibly attached might be removed with the coating, which would allow more the original membrane permeability to be recovered after recovery cleaning. Considering a range of applications, a coating may be useful if provides any one or more of, an improvement in short term fouling rate; an improvement in permeability recovery after maintenance cleaning or the ability to use a less intensive maintenance cleaning procedure; or, a means of reducing or partially reversing long-term permeability loss.

One useful membrane coating may be made from a polymerized form of catechol. Catechol is also known as pyrocatechol; 1,2-dihydroxybenzene; or, by the IUPAC name benzene-1,2-diol. It has the formula C₆H₄(OH)₂. Structurally, catechol has a benzene ring, or aromatic hydrocarbon group, with two hydroxyl substituents. As such, it is phenolic in that it has an aromatic hydrocarbon group and at least one hydroxyl group. It is available commercially in the form of white crystals sold, for example, for use in making fertilizer.

Catechol is readily oxidized and polymerized when exposed to air in an alkaline solution at a pH of 7.5 or more. A higher pH increases the reaction rate. Subsequent C-C bond formation results in aryl-aryl couplings leading to the formation of polyphenolic polymers. Catechol derivatives are likely to polymerize in this way. The general structure of polycatechol is illustrated below.

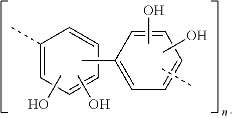

Compared for example to polydopamine, catechol or related substances may be preferable for one or more reasons in addition to their compatibility with maintenance and recovery cleaning regimes as discussed above. For example, catechol is commercially available and less expense than dopamine or dopamine analogues. Since municipal water and wastewater treatment systems can require thousands of square meters of surface area, expense and availability are serious concerns. Further, dopamine is a neurotransmitter in the human brain and the industrial use of dopamine or its derivatives, particularly if coating is performed at a filtration site rather than in a factory, may raise health concerns for workers.

While poly(dopamine) might not have similar biological effects, it would also need to be considered whether a poly(dopamine) coated membrane is appropriate for use in treating drinking water or discharging large volumes of water into the environment. Poly(catechol) also seem to adhere selectively to the membrane and not to dense plastics or glass, which may help avoid complications with applying the coating to finished membrane modules, particularly in the field.

Other compounds may also be used to form polyphenol type polymeric membrane coatings. In general, a compound may comprise a benzene-diol or a substituted phenol group as illustrated in the structure below.

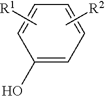

In this structure, R¹ is preferably —OH but may alternatively be —NHR³ (R³: —H, alkyl- or aryl-group).

R² is optional but if present can be any feasible substituent, such as an (substituted) alkyl-, aryl-, acyl-, alkoxy-group, amino-alkyls, alkyl-imines, polyethylene glycol (PEG), polypropylene glycol or similar polyalkylene glycols (polyethers), polyethylene amines (polyimines), or other sidechains compatible with aqueous solubility. The substituent may be further modified or substituted, or both, with one or more alkyl, aryl, alkoxy, acyl, sulfonyl groups, hydroxyls or amines, halogens, and combinations thereof. R² can also be another dihydroxy-aryl or amino-hydroxy-aryl group, or an oligomer of such groups.

The compound may also be a multi-ring compound, such as tannic acid or humic acid, that can also be polymerized either alone or in combination with other starting materials.

A ring-condensed substitution, for example as pictured below, is also possible, with X representing a mono- or multi-fused ring that can be aromatic or saturated.

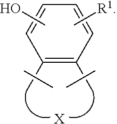

The above-mentioned starting materials can be used either alone or in combination as a mixture, to produce co-polymers in the later case.

The (auto-)oxidation of catechols and analogues is described in an article by McBride and Sikora called Catalysed Oxidation Reactions of 1,2-dihydroxybenzene (Catechol) in Aerated Aqueous Solutions of Al3+, Journal of Inorganic Biochemistry 39:247 and Ozone and Oxygen Induced Oxidative Coupling of Aqueous Phenolics (Chrostowski et al., Water Research Vol. 17, No. 11, pp 1627-1633, 1983). These papers treat the polymer formation as an undesirable side reaction. However, to the extent that catechol analogues may have oxidation characteristics similar to catechol, it can be predicted that these anologues may also be polymerized intentionally in a manner similar to catechol.

Alternatively, a 1966 article by Ladd and Butler, Comparison of Some Properties of Soil Humic Acids and Synthetic Phenolic Polymers Incorporating Amino Derivatives (Australian Journal of Soil Research 4:41) describes a method of synthesizing polyphenolic co-polymers, starting from dihydroxybenzenes in combination with other monomers. It may be possible to use these methods to produce co-polymers or polyphenol type polymers described herein.

Among the range of starting materials mentioned above, we presently prefer catechol, catechols with an R2 substituent other than amine or thiol, and catechol with a PEG R2 substituent.

We have adhered polycatechol to membranes of PVDF, cellulose acetate, polyamide and polyethersulfone. Given this range of materials, and reported results relating to polydopamine and similar polymers, we expect polycatechol and the other polymers described herein to adhere it to similarly adhere to polysulfone and any other filtering membrane material.

Under reaction conditions, for example as described below, catechol forms polycatechol on the membrane surface. When other monomers are used, for example substituted di- or trihydroxy-aryl monomer starting materials (R₁: HO—, Alkyl-, Aryl-, etc., R₂: Alkyl-, Aryl-, PEG-O—, PEG-N—, etc.), we expect these compounds to form a polymer end product via an oxidative coupling pathway, applying a semiquinone intermediate, according to the polymerization scheme presented below.

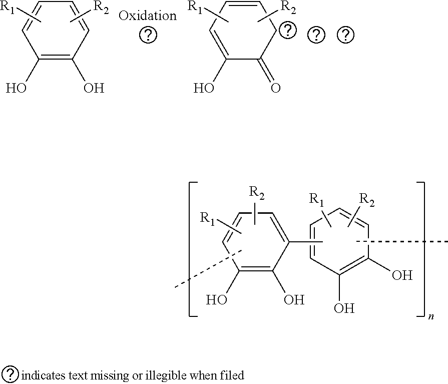

Without intending to be limited to any particular theory, we believe that the hydroxyl moieties give the coating a hydrophilic character. Functionalization of catechol with a hydrophilic polymer sidechain, such as PEG, can be expected to provide the surface with an additional source of hydrophilicity and antifouling character due to the known antifouling qualities of PEG.

A polyphenol-type coating on an outside-in membrane can be generated by soaking the membrane fiber (bath ratio: 10-500 cm³/m of hollow fiber membrane) in a 0.002-2.0 w/w% aqueous phenolic-compound solution at a pH of 7.5-11.5 for 0.5-48 hours, optionally at room temperature, while applying continuous aeration (for example at 10-250 cm³ air/L/min) in the reaction mixture. The membranes may be potted into a module before they are coated. The thickness of the coating increases with increased immersion time and with concentration.

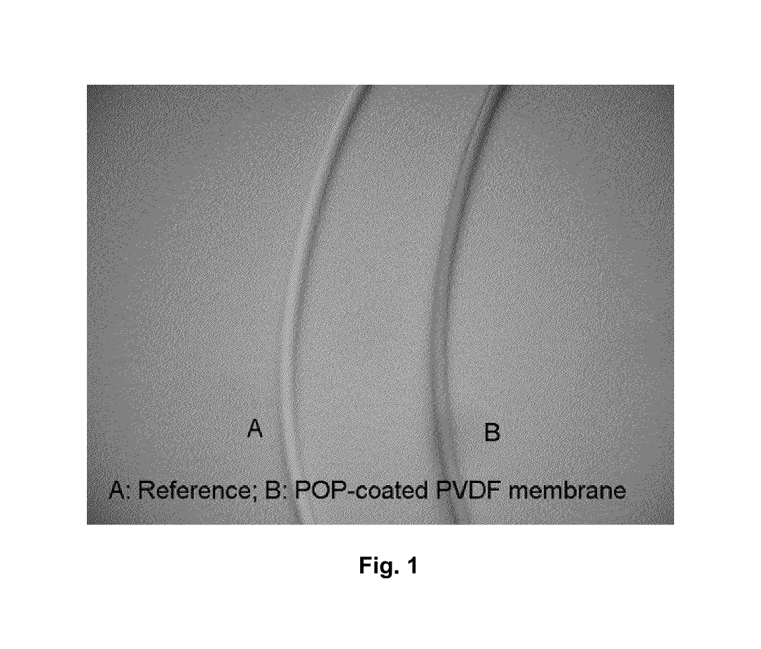

FIG. 1 shows an uncoated PVDF based hollow fiber membrane on the left and a PVDF based hollow fiber membrane coated with polycatechol on the right. The coated membrane has a grey-brown colour compared to the white reference membrane. The coating becomes darker indicating a more intense coating with increased immersion time.

Some other properties of the polycatechol coated membrane listed below also suggest that the coating is thin and highly porous. Data for a reference uncoated membrane are included in brackets for comparison purposes.

Color [−] grey-brown (white)

Burst pressure [psi] 36 (38)

Permeability [gfd/psi] 41 (35) based on a 95 cm long dead end fibers.

Bubble-point pore diameter [micron] 0.024 (0.022)

PEO 200 k rejection [%] 88 (71)

The coating layer is durable while the membrane is filtering water and does not mechanically scrub off the membrane. However, the coating can be washed off of dense plastics and glass.

The coating can be oxidized, or partially removed, from the membranes with an oxidant, for example by soaking the membrane in a 100-1000 ppm hypochlorite solution at room temperature for 10-60 minutes. Soaking in a 100 ppm hypochlorite solution whitens the coating but the fouling performance after cleaning suggests that the coating is still at least partially present even after multiple maintenance cleanings, for example three cleanings or more or five cleanings or more. Soaking in a 1000 ppm hypochlorite may remove more, or possibly all, of the coating. The coating and removal cycle can be repeated.

Either or both of the coating and the removal processes may be performed in the field, at least with immersed outside-in membrane modules, by performing the reactions in the membrane tank. During the coating procedure, scouring aerators ordinarily used during the filtration process may be used to aerate the coating solution.

### Experimental Example

A coating solution was prepared by dissolving 42.0 g of NaHCO₃, 53.0 g of Na₂CO₃ and 10.0 g of catechol in 10 litres of purified water. Two modules of hollow fiber PVDF membranes, having an outer skin functioning as a separation layer, were made having 0.9 square meters (9.8 square feet) of membrane area. One of the modules was coated with poly(catechol) by immersing it in the solution for 6 hours while 2 standard cubic feet per minute (SCFM) of aeration was applied. The second module was left uncoated to provide a reference for comparison. The two modules were operated in a membrane bioreactor system characterized by the parameters listed in Table 1.

TABLE 1

| Tank volume (Reactor) | 500 | liters |
|---|---|---|
| Membrane tank volume | 250 | liters |
| Hydraulic retention time (HRT) | 3-6 | Hours |
| Mixed liquor suspended solids (MLSS) in | ~8 | g/l |
| bioreactor tank | | |
| Food:microorganisms (F/M) ratio (Kg of | ~0.1-0.15 | |
| COD/Kg of VSS) | | |
| Organic loading rate (Kg of COD/M3) | ~1-1.3 | |
| Aeration rate | 2 SCFM to each module | |
| Aeration sequence during filtration cycle | 10s/30s on/off | |
| (permeate production and relaxation) | | |
| Dissolved oxygen (DO) (In bioreactor) | ~1.5-2 | mg/l |
| Permeate production time per filtration cycle | 12 | minutes |
| Relaxation time per filtration cycle | 30 | seconds |

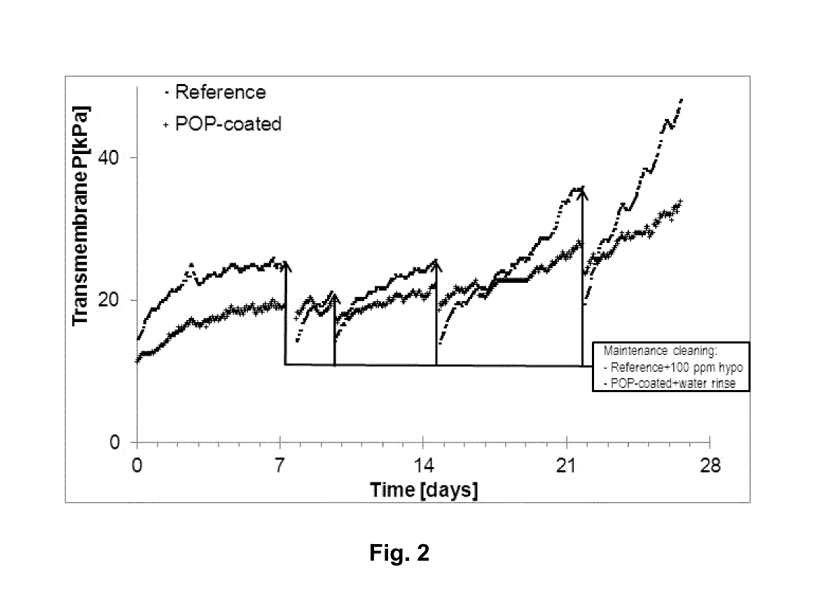

Transmembrane pressures were recorded over a 2-week period. The flux during the permeate production part of each filtration cycle was kept constant at 40 gallons/square feet/day (GFD) [convert to metric]. The transmembrane pressure (TMP) was measured during the tests and recorded in FIGS. 2, 3 and 4.

Referring to FIG. 2, the coated module had a very low initial fouling rate of around 1 kPa/day. This was less than the fouling rate of the uncoated reference module during the same time period, which was typically about 2.5 kPa/day. Maintenance cleaning procedures were performed at about days 7, 10, 14 and 22. The coated module was cleaned by a water rinse while the uncoated module was cleaned with a 100 ppm hypochlorite solution. As indicated in FIG. 2, the water rinse was an effective recovery cleaning process for the coated module whereas, from past experience, it is known that a water rinse would not have been effective for the coated module. After about 25 days, the uncoated module was operating at a significantly higher TMP than the coated module to maintain the same constant flux.

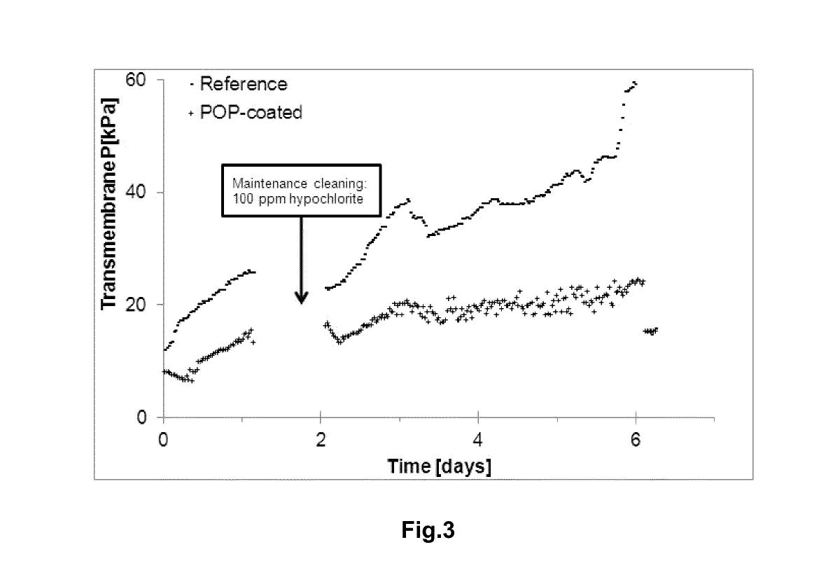

Referring to FIG. 3, in a similar trial both modules were maintenance cleaned with a 100 ppm hypochlorite solution. The coated module appeared whiter after the cleaning. However, as indicated in FIG. 3, the coated module continued to have a lower fouling rate than the uncoated module after the maintenance cleaning.

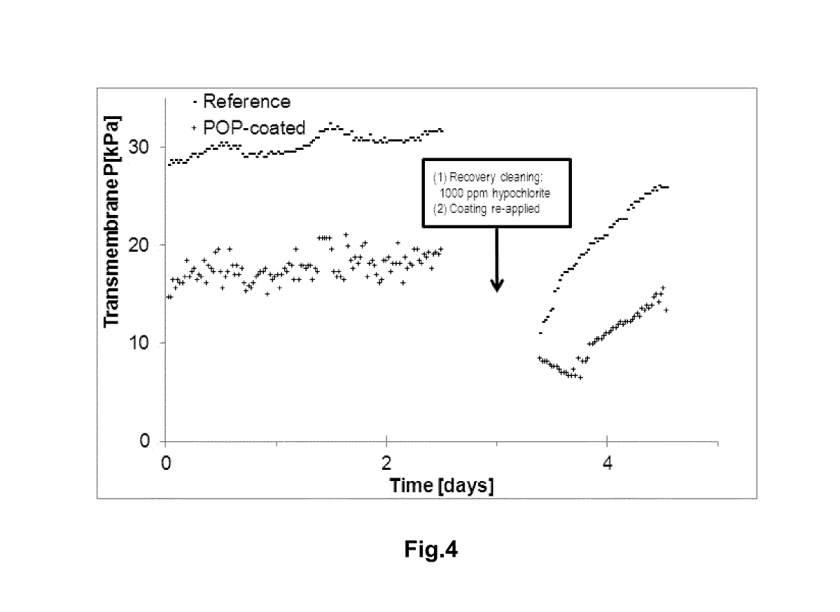

Referring to FIG. 4, in a similar trial both modules were recovery cleaned with a 1000 ppm hypochlorite solution. The coating was re-applied to the coated module after the cleaning. As indicated in FIG. 4, the coated module continued to have a reduced fouling rate relative to the uncoated module after the recovery cleaning and re-coating procedure.

Other membranes were also coated with polycatechol by immersing them in the coating solution described above while aerating the solution. In one example, a supported polyamide based reverse osmosis membrane, normally used in a spiral would module, was coated. In another example, a cellulose acetate membrane sheet was cast onto a solid surface and later coated. In another example, a polyethersulfone hollow fibre membrane was coated. In all of these examples, successful application of the coated was verified by a grey-brown colour of the coated membranes.

We claim:

1. A coated membrane comprising,
a) a membrane; and,
b) a coating on the membrane, the coating comprising a polymer or co-polymer made from a compound selected from the group of:
(i) a compound having a structure as illustrated below: 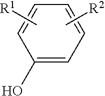
wherein R¹ is —OH or —NHR³, R³ being selected from the group of —H and alkyl- or aryl-groups, and R² is not present or is a feasible substituent;
(ii) a multi-ring compound; and,
(iii) a compound having a structure as illustrated below: 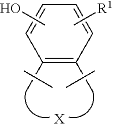
wherein R¹ is —OH or —NHR³, R³ being selected from the group of —H and alkyl- or aryl-groups, and X is a mono- or multi-fused ring.

2. The coated membrane of claim 1 wherein the compound is according to part (i) of claim 1.

3. The coated membrane of claim 2 wherein wherein R¹ is —OH.

4. The coated membrane of claim 3 wherein R² is present and selected from the group of substituted alkyl-, aryl-, acyl-, alkoxy-group, amino-alkyls, alkyl-imines, polyethylene glycol (PEG), polypropylene glycol, polyalkylene glycols (polyethers), polyethylene amines (polyimines), other sidechains compatible with aqueous solubility, another dihydroxy-aryl or amino-hydroxy-aryl group, an oligomer of such groups, and such substituents further modified or substituted with one or more alkyl, aryl, alkoxy, acyl, sulfonyl groups, hydroxyls or amines, halogens, or combinations thereof.

4. The coated membrane of claim 3 wherein R² is present but is not an amine or thiol.

5. The coated membrane of claim 3 wherein R² is PEG.

6. The coated membrane of claim 3 wherein the compound is catechol.

7. The coated membrane of claim 6 wherein the polymer is polycatechol.

8. The coated membrane of claim 1 wherein the membrane is a polymeric membrane.

9. The coated membrane of claim 8 wherein the membrane comprises polyvinylidene fluoride, polyamide, cellulose acetate or polyethersulfone.

10. The coated membrane of claim 9 wherein the membrane comprises polyvinylidene fluoride.

11. The membrane of claim 1 wherein the microporous membrane is an outside-in hollow fiber membrane.

12. A method of making a filtering membrane module comprising the steps of:
a) potting outside-in hollow fibre membranes into a module;
b) immersing the module in a solution of a compound comprising a benzene-diol or a substituted phenol; and,
c) forming a polymer or co-polymer of the compound on the outer surfaces of the membranes.

13. The method of claim 12 wherein the solution is alkaline and has a pH of 7.5 or more.

14. The method of claim 13 comprising a step of aerating the solution while the module is immersed in the solution.

15. The method of claim 14 wherein the compound is catechol.

16. The method of claim 12 wherein the membranes comprise PVDF.

17. A process for treating water comprising the steps of,
a) immersing a polymeric membrane coated with polycatechol into the water;
b) withdrawing filtered water through the membrane for a period of time;
c) after the period of time, washing the membrane with water or an aqueous solution comprising an oxidant at a concentration of 200 ppm or less.

18. The process of claim 17 further comprising steps of,
d) resuming withdrawing filtered permeate through the membrane after step c) for a further period of time; and,
e) after the further period of time, cleaning the membrane with an aqueous solution comprising an oxidant at a concentration of 500 ppm or more.

19. The process of claim 18 further comprising a step of re-coating the membrane with polycatechol after step e).

20. The process of claim 17 wherein the membrane comprises PVDF.
